(19) United States
(12) Patent Application Publication
(10) Pub. No.: US 2009/0019122 A1
(43) Pub. Date: Jan. 15, 2009

(54) Direct mailing in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/827,834

(22) Filed: Jul. 12, 2007

(51) Int. Cl. G06F 15/16

(52) U.S. Cl. 709/206

(57) ABSTRACT

A method and system of direct mailing in a geo-spatial environment are disclosed. In one embodiment, a method includes generating a community network of user profiles, each user profile associated with a specific geographic location and at least one contact address, associating a first user with a first user profile, selecting a mail mode, selecting a communication, generating a first display view to include a three-dimensional map view embodied by the community network, at least a portion of the user profiles represented at a location in the three-dimensional map view associated with the specific geographic location of the first user profile, selecting a second user profile from the portion of the user profiles, and generating a mailing of the communication, in a format associated with the mail mode, between the first user profile and the contact address associated with the second user profile.

### FIELD OF TECHNOLOGY

This disclosure relates generally to the technical field of communications and in one example embodiment, to a method and system of direct mailing in a geo-spatial environment.

### BACKGROUND

People use real mail and physical mail (e.g., postal mail, courier service) to contact others. Real mail may be difficult to use, however, if an intended recipient's email address is not easily ascertainable. For example, the intended recipient may not be a member of a social network providing member email addresses or the intended recipient's email address may be private.

Physical mail may also be difficult to use. A sender may produce the physical item to be mailed, locate an address for the intended recipient, buy and affix postage to the item, and find a mailbox or other depository to dispatch the item.

Bulk mail to multiple intended recipients may present additional issues. The sender may not know the addresses of multiple intended recipients. The sender may purchase address list(s) of the multiple intended recipients. The sender may expend time and effort producing multiple copies of the items to be mailed. The sender may expend time and effort to address and post each of the items to each of the multiple recipients. Alternatively, the sender may incur costs hiring a company to procure address lists, produce the items, and deliver the items.

### SUMMARY

A method and system of direct mailing in a geo-spatial environment are disclosed. In one aspect, a method includes generating a community network of user profiles, each user profile associated with a specific geographic location and at least one contact address (e.g., the contact address may be based on the mail mode and selected from a group including a physical mailing address associated with the specific geographic location of the user profile, a facsimile number, an email address, and/or an instant message user identifier, etc.), associating a first user with a first user profile, selecting a mail mode (e.g., the mail mode may include a physical mail mode, a facsimile mode, an email mode, and/or an instant message mode, etc.), selecting a communication, generating a first display view to include a three-dimensional map view embodied by the community network, at least a portion of the user profiles represented at a location in the three-dimensional map view associated with the specific geographic location of the first user profile, selecting a second user profile from the portion of the user profiles, and generating a mailing of the communication, in a format associated with the mail mode, between the first user profile and the contact address associated with the second user profile.

In addition, the method may include selecting a physical mail mode, and generating the mailing of the communication, in a physical format associated with the physical mail mode, between the first user profile and the contact address (e.g., the contact address may be based on a physical address associated with the second user profile) associated with the second user profile. The method may further include selecting a facsimile mode, and generating the mailing of the communication, in a facsimile format associated with the facsimile mode, between the first user profile and the contact address (e.g., the contact address may be based on the facsimile number associated with the second user profile) associated with the second user profile. The method may also include selecting an email mode, and generating the mailing of the communication, in an email format associated with the email mode, between the first user profile and the contact address (e.g., the contact address may be based on an email address associated with the second user profile) associated with the second user profile.

The method may yet include selecting an instant message mode, and generating the mailing of the communication, in an instant message format associated with the instant message mode, between the first user profile and the contact address (e.g., the contact address may be based on the instant message user identifier associated with the second user profile) associated with the second user profile. In addition, the method may include selecting the location in the three-dimensional map view from a group including a street address, a city, a county, a state, and/or a country, etc.

The method may further include selecting a radius associated with the location in the three-dimensional map view, and selecting the user profiles of the portion of the user profiles having specific geographic locations included in the radius. The method may yet include providing demographics associated with the community network, associating at least one of the demographics with each user profile, selecting at least one demographic, and selecting the user profiles having specific geographic locations included in the radius and having the demographic (e.g., age, age range, gender, occupation, ethnicity, location of a residence, location of a business, marital status, ownership status, language, mobility, income, life cycle, socioeconomic status, and/or lifestyle, etc.).

The method may also include generating an online commerce transaction (e.g., an online transaction associated with payment of postage and payment of services related to the mailing of the communication) associated with the mailing of the communication. The method may further include scheduling the mailing of the communication (e.g., by determining a number of mailings, determining a time period, and generating the number of mailings within the time period). In addition, the method may include creating the communication.

In another aspect, a system includes a geo-spatial environment, a community network module of the geo-spatial environment, to include user profiles, each user profile to include a specific geographic location and/or a contact address (e.g., may be selected from a group including a physical mailing address associated with the specific geographic location of the user profile, a facsimile number, an email address, and/or an instant message user identifier, etc.), a map module of the geo-spatial environment to include map data which serves as a basis to render a three-dimensional map view in the geo-spatial environment which identifies at least some residences, businesses, and/or civic structures having specific geographic locations, a mail mode module of the geo-spatial environment to determine a mail mode (e.g., a physical mail mode, a facsimile mode, an email mode, and/or an instant message mode, etc.), a communication module of the geo-spatial environment to select a communication, a display module of the geo-spatial environment to generate a first display view to include a three-dimensional map view embodied by a community network, at least a portion of the user profiles represented at locations in the three-dimensional map view associated with the specific geographic locations of the portion of the user profiles, a recipient module of the geo-spatial environment to select a user profile from the portion of the user profiles, and a mail communication module of the geo-spatial environment to generate a mailing of the communication, in a format associated with the mail mode, to a contact address associated with the user profile.

In addition, a system may include a commerce transaction module of the geo-spatial environment to generate a commerce transaction associated with the elements. The system may also include a postage module of the geo-spatial environment to generate an online transaction associated with payment of postage, and a service payment module of the geo-spatial environment to generate an online transaction associated with payment of services related to mailing the communication.

The system may yet include a location module to select the location (e.g., the location may be selected from a group including a street address, a city, a county, a state, and/or a country, etc.). The system may further include a radius module to determine a radius based on the location, and to display the portion of the user profiles having specific geographic locations included in the radius. The system may also include a demographic module to provide demographics associated with the user profiles, to select at least one demographic (e.g., the demographics may include age, age range, gender, occupation, ethnicity, location of a residence, location of a business, marital status, ownership status, language, mobility, income, life cycle, socioeconomic status, and/or lifestyle, etc.), and/or to determine a group of user profiles, in which the demographic is associated with each user profile.

In addition, the system may include a scheduler module to schedule the mailing (e.g., the schedule may be based on a selected number of mailings per a predetermined time period). The system may yet include a document creation module to enable creation of a document. The system may also include a letter creation module to enable creation of letters, and a marketing brochure creation module to enable creation of marketing brochures.

In yet another aspect, a geo-spatial environment includes a first instruction set to enable a community network, to include a map database associated with map data and a user database associated with user profiles, each user profile associated with a specific geographic location identifiable in the map data and/or a contact address, a second instruction set integrated with the first instruction set to display a three-dimensional map view, embodied by the community network, to include representations (e.g., each representation of a user profile may be displayed at a location in the three-dimensional map view corresponding to the specific geographic location associated with the user profile) of at least a portion of the user profiles, a third instruction set integrated with the first instruction set and the second instruction set to determine a second user profile, a communication, and a mail mode, and a fourth instruction set integrated with the first instruction set, the second instruction set and the third instruction set to generate a mailing of the communication, in a format associated with the mail mode, to the contact address (e.g., the contact address may be based on the mail mode) associated with the second user profile.

In addition, the geo-spatial environment may include a fifth instruction set to generate a commerce transaction associated with the mailing of the communication. The geo-spatial environment may also include a sixth instruction set to schedule the mailing of the communication and a seventh instruction set to enable creation of the communication.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a geo-spatial environment communicating with users through a network, according to one embodiment.

FIG. 2 is an exploded view of the community network module of FIG. 1, according to one embodiment.

FIG. 3 is an exploded view of the additional modules of FIG. 1, according to one embodiment.

FIG. 4 is schematic representation of data communication between the first user and the contact address associated with the second user profile, according to one embodiment.

FIG. 5 is a user interface view of Pizza Heaven's profile, according to one embodiment.

FIG. 6 is a user interface view of my mailing menu, according to one embodiment.

FIG. 7 is a user interface view of the marketing brochure creation module of FIG. 3, according to one embodiment.

FIG. 8 is a user interface view of the recipient module of FIG. 1, according to one embodiment.

FIG. 9 is a user interface view of selecting matching recipients for mailing of communication, according to one embodiment.

FIG. 10 is a user interface view of scheduling, sending mails and making transactions associated with payment of services related to the mailing of the communication, according to one embodiment.

FIG. 11 is a table view showing details of the mailing of the communication associated with the users, according to one embodiment.

FIG. 12 is a diagrammatic system view of a data processing system in which any of the embodiments disclosed herein may be performed, according to one embodiment.

FIG. 13A is a process flow of direct mailing based on selection of mailing modes, according to one embodiment.

FIG. 13B is a continuation of the process flow of FIG. 13A illustrating additional processes, according to one embodiment.

FIG. 13C is a continuation of the process flow of FIG. 13B illustrating additional processes, according to one embodiment.

FIG. 13D is a continuation of the process flow of FIG. 13C illustrating additional processes, according to one embodiment.

Other features of the present embodiments will be apparent from the accompanying drawings and from the detailed description that follows.

### DETAILED DESCRIPTION

A method and system of direct mailing in a geo-spatial environment are disclosed. In the following description, for the purposes of explanation, numerous specific details are set forth in order to provide a thorough understanding of the various embodiments. It will be evident, however to one skilled in the art that the various embodiments may be practiced without these specific details.

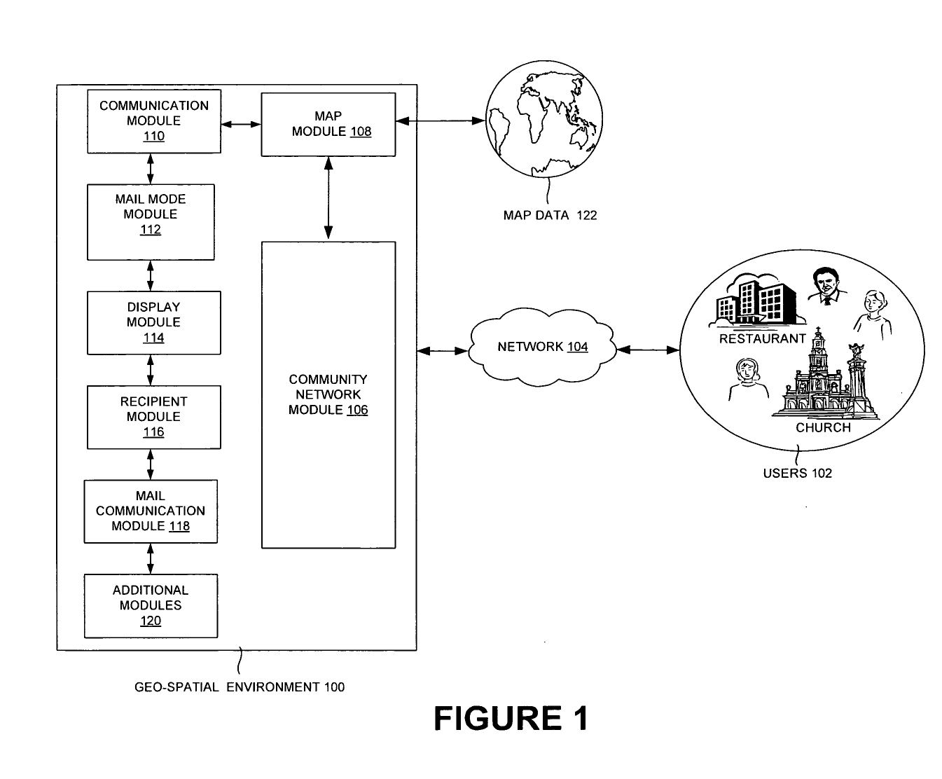

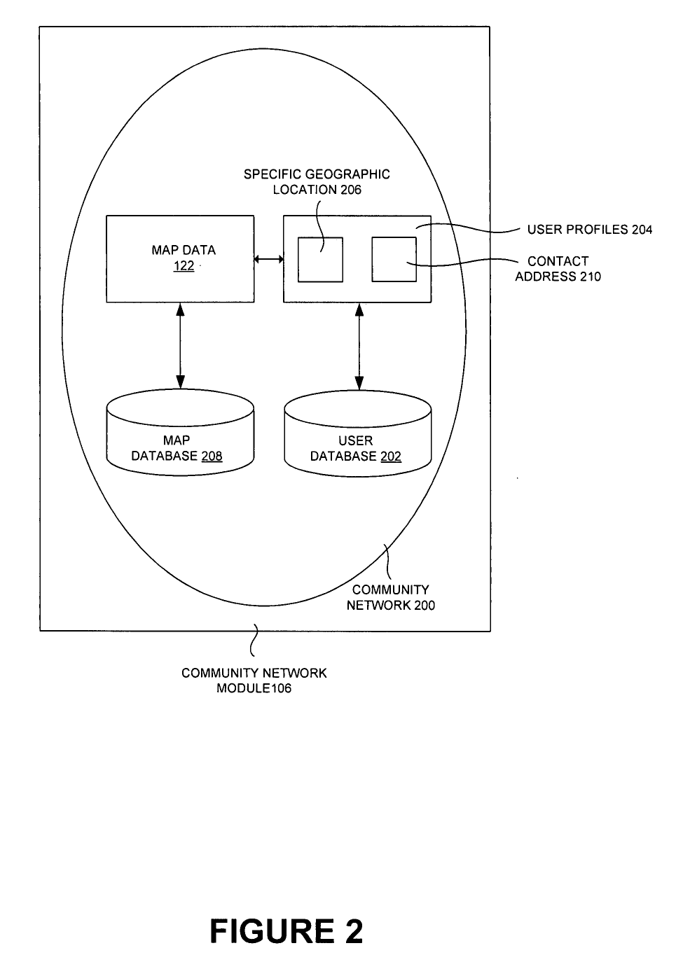

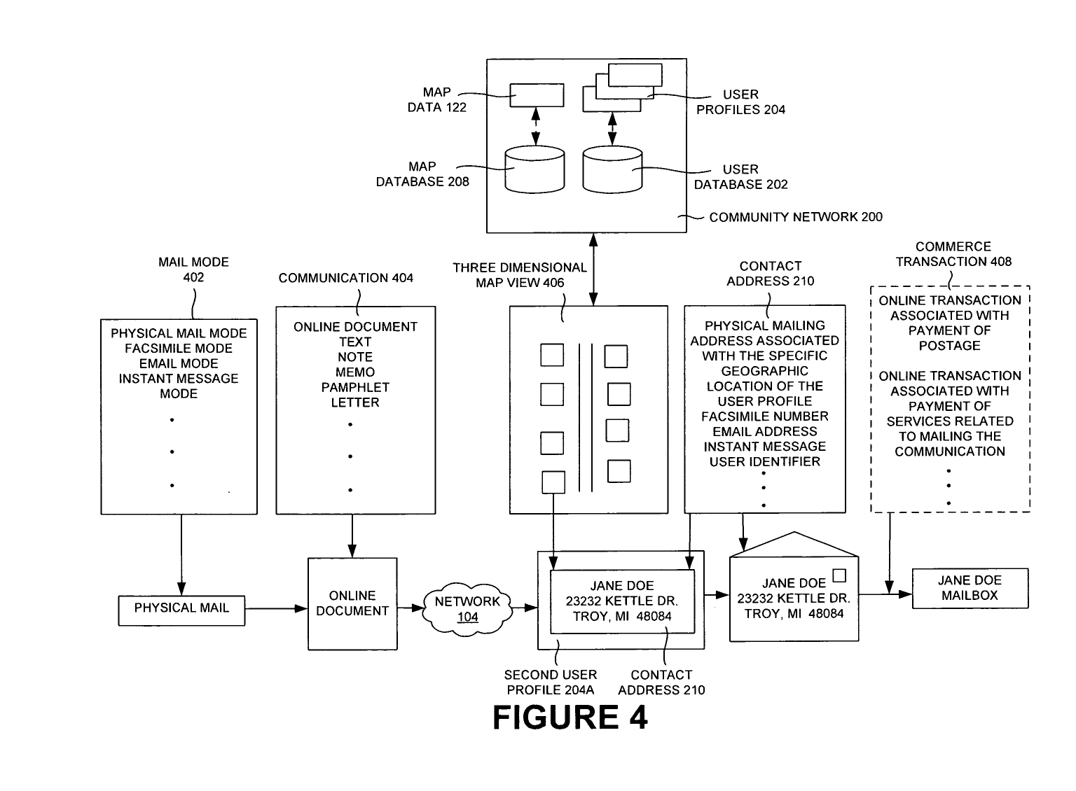

In one embodiment, a method includes generating a community network (e.g., the community network 200 of FIG. 2) of user profiles (e.g., the user profiles 204 of FIG. 2), each user profile 204 associated with a specific geographic location (e.g., the specific geographic location 206 of FIG. 2) and a contact address (e.g., the contact address 210 of FIG. 2), associating a first user (e.g., of the users 102 of FIG. 1) with a first user profile 204, and selecting a mail mode (e.g., the mail mode 402 of FIG. 4), selecting a communication (e.g., the communication 404 of FIG. 4).

The method also includes generating a first display view to include a three-dimensional map view (e.g., the three-dimensional map view 406 of FIG. 4) embodied by the community network 200, a portion of the user profiles 204 represented at a location in the three-dimensional map view 406 associated with the specific geographic location 206 of the first user profile 204, selecting a second user profile 204A from the portion of the user profiles 204, and generating a mailing of the communication 404, in a format associated with the mail mode 402, between the first user profile 204 and the contact address 210 (e.g., the contact address 210 may be based on the mail mode 402) associated with the second user profile 204A.

In another embodiment, a system includes a geo-spatial environment (e.g., the geo-spatial environment 100 of FIG. 1), a community network module (e.g., the community network module 106 of FIG. 1) of the geo-spatial environment 100, to include user profiles 204, each user profile 204 to include a specific geographic location 206 and a contact address 210, a map module (e.g., the map module 108 of FIG. 1) of the geo-spatial environment 100 to include map data (e.g., the map data 122 of FIG. 1) which serves as a basis to render a three-dimensional map view 406 in the geo-spatial environment 100 which identifies residences, businesses, and/or civic structures having specific geographic locations 206, a mail mode module (e.g., the mail mode module 112 of FIG. 1) of the geo-spatial environment 100 to determine a mail mode 402, and a communication module (e.g., the communication module 110 of FIG. 1) of the geo-spatial environment 100 to select a communication (e.g., the communication 404 of FIG. 4).

The system also includes a display module (e.g., the display module 114 of FIG. 1) of the geo-spatial environment 100 to generate a first display view to include a three-dimensional map view 406 embodied by a community network 200, a portion of the user profiles 204 represented at locations in the three-dimensional map view 406 associated with the specific geographic locations 206 of the portion of the user profiles 204, a recipient module (e.g., the recipient module 116 of FIG. 1) of the geo-spatial environment 100 to select a user profile 204 from the portion of the user profiles 204, and a mail communication module (e.g., the mail communication module 118 of FIG. 1) of the geo-spatial environment 100 to generate a mailing of the communication 404, in a format associated with the mail mode 402, to a contact address 210 associated with the user profile 204.

In yet another embodiment, a geo-spatial environment 100 includes a first instruction set to enable a community network (e.g., the community network 200 of FIG. 2), to include a map database (e.g., the map database 208 of FIG. 2) associated with the map data 122 and a user database (e.g., the user database 202 of FIG. 2) associated with user profiles 204, each user profile 204 associated with a specific geographic location (e.g., the specific geographic location 206 of FIG. 2) identifiable in the map data 122 and a contact address (e.g., the contact address 210 of FIG. 2), and a second instruction set integrated with the first instruction set to display a three-dimensional map view 406, embodied by the community network 200, to include representations of a portion of the user profiles 204 (e.g., each representation of the user profile 204 may be displayed at a location in the three-dimensional map view 406 corresponding to the specific geographic location 206 associated with the user profile 204).

The geo-spatial environment 100 also includes a third instruction set integrated with the first instruction set and the second instruction set to determine a second user profile 204A of the portion of the user profiles 204, a communication (e.g., the communication 404 of FIG. 4), and a mail mode (e.g., the mail mode 402 of FIG. 4), and a fourth instruction set integrated with the first instruction set, the second instruction set and the third instruction set to generate a mailing of the communication 404, in a format associated with the mail mode 402, to the contact address 210 (e.g., the contact address 210 may be based on the mail mode 402) associated with the second user profile 204A.

FIG. 1 is a system view of a geo-spatial environment 100 communicating with users 102 through a network 104, according to one embodiment. Particularly, FIG. 1 illustrates the geo-spatial environment 100, the users 102, the network 104, a community network module 106, a map module 108, a communication module 110, a mail mode module 112, a display module 114, a recipient module 116, a mail communication module 118, additional modules 120 and map data 122, according to one embodiment.

The geo-spatial environment 100 may enable the users 102 to directly mail and communicate with each other. The users 102 may be registered and/or unregistered users associated with user profiles 204 communicating through a mail mode 402 (e.g., a physical mail mode, facsimile mail mode, an email mode and/or instant message mode, etc.) in the geo-spatial environment 100. The network 104 may facilitate communication between the users 102 and the geo-spatial environment 100. The community network module 106 may generate a community network (e.g., the community network 200 of FIG. 2) of the user profiles 204 associated with specific geographic locations 206 and contact addresses 210 in the geo-spatial environment 100.

The map module 108 may generate a three-dimensional map view (e.g., the three-dimensional map view 406 of FIG. 4) that renders the specific geographic location(s) 206 of the user profile(s) 204 (e.g., the location may be associated with the first user profile 204 and the second user profile 204A) associated with the communication 404 adjacent to the other profiles 204 using the map data 122 in the geo-spatial environment 100.

The communication module 110 may enable selection and/or generation of the communication 404 associated with a user profile 204 having specific geographic locations 206. The mail mode module 112 may determine a mail mode (e.g., a physical mail mode, a facsimile mode, an email mode, an instant message mode, etc.) for mailing of the communication 404 in a format associated with the mail mode 402. The display module 114 may generate a first display view which includes the three-dimensional map view 406 embodied by the community network 200 in the geo-spatial environment 100. The recipient module 116 may enable selection of a user profile 204 associated with the contact address 210 for mailing of the communication 404 through a particular mail mode in the geo-spatial environment 100.

The mail communication module 118 may generate the mailing of the communication 404 between the first user profile 204 and the contact address 210 associated with the second user profile 204A, in a format associated with the mail mode 402 (e.g., the physical mail mode, the facsimile mode, the email mode, the instant message mode, etc.). The additional modules 120 may generate additional processes to enable the communication 404 through a mail mode 402. The map data 122 may include details of maps of any region, area and/or neighborhood in the geo-spatial environment 100 which serves as a basis to identify residences, businesses, and/or civic structures having specific geographic locations 206 in the three-dimensional map view 406.

In the example embodiment illustrated in FIG. 1, the users 102 communicate with the geo-spatial environment 100 through the network 104. The geo-spatial environment 100 includes the community network module 106, the map module 108, the communication module 110, the mail mode module 112, the display module 114, the recipient module 116, the mail communication module 118 and the additional modules 120 communicating with each other. In addition, the map module 108 communicates with the map data 122.

The community network module 106 of the geo-spatial environment 100 may include the user profiles 204, each user profile 204 to include a specific geographic location 206 and a contact address 210. The map module 108 of the geo-spatial environment 100 may include map data 122 which serves as a basis to render the three-dimensional map view 406 in the geo-spatial environment 100 which identifies the residences, the businesses, and/or the civic structures having specific geographic locations 206. The mail mode module 112 of the geo-spatial environment 100 may determine a mail mode (e.g., the mail mode 402 of FIG. 4). The communication module 110 of the geo-spatial environment 100 may select a communication (e.g., the communication 404 of FIG. 4).

The display module 114 of the geo-spatial environment 100 may generate the first display view to include the three-dimensional map view 406 embodied by the community network 200, a portion of the user profiles 204 represented at locations in the three-dimensional map view 406 associated with the specific geographic locations 206 of the portion of the user profiles 204. The recipient module 116 of the geo-spatial environment 100 may select the user profile 204 from the portion of the user profiles 204. The mail communication module 118 of the geo-spatial environment 100 may generate the mailing of the communication 404, in a format associated with the mail mode 402, to a contact address (e.g., the contact address 210 of FIG. 2) associated with the user profile 204.

FIG. 2 is an exploded view of the community network module 106 of FIG. 1, according to one embodiment. Particularly, FIG. 2 illustrates the map data 122, a community network 200, a user database 202, user profiles 204, a specific geographic location 206, a map database 208 and a contact address 210, according to one embodiment.

The community network 200 may be a network of people, places and/or businesses in the geo-spatial environment 100 associated with the user profiles 204, each user profile 204 having a specific geographic location (e.g., the specific geographic location 206 of FIG. 2) and a contact address (e.g., the contact address 210 of FIG. 2). The user database 202 may include the user profiles 204 associated with the specific geographic location 206 and the contact address 210 in the community network 200. The user profiles 204 may refer to the user profiles (e.g., including age data, interest data, occupation data, etc.) which are associated with the specific geographic location 206 involved in the communication 404 through the mail mode 402.

The specific geographic location 206 may refer to the specific location of the users 102 associated with the user profile 204. The map database 208 may include the map data 122 of any area, region and/or neighborhood of the users 102 associated with the user profiles 204. The contact address 210 may be a physical mailing address (e.g., associated with a specific geographic location 206 of a user profile 204), a facsimile number, an email address, and/or an instant message user identifier used for the communication 404 based on the mail mode 402.

In the example embodiment illustrated in FIG. 2, the community network module 106 includes the community network 200 including the map database 208 and the user database 202 communicating with each other. In addition, the user database 202 includes the user profiles 204, the specific geographic location 206 and the contact address 210, according to the example embodiment illustrated in FIG. 2.

The community network 200 of the user profiles 204 may be generated, each user profile 204 associated with the specific geographic location 206 and the contact address 210. The contact address 210 may be selected from a group including a physical mailing address associated with the specific geographic location 206 of the user profile 204, a facsimile number, an email address, and/or an instant message user identifier, etc. The first user 102 may be associated with a first user profile 204. The communication 404 may be created.

The geo-spatial environment 100 may include a first instruction set to enable the community network 200 that includes the map database 208 associated with the map data 122 and the user database 202 associated with user profiles 204. Each user profile 204 may be associated with the specific geographic location 206 identifiable in the map data 122 and the contact address 210.

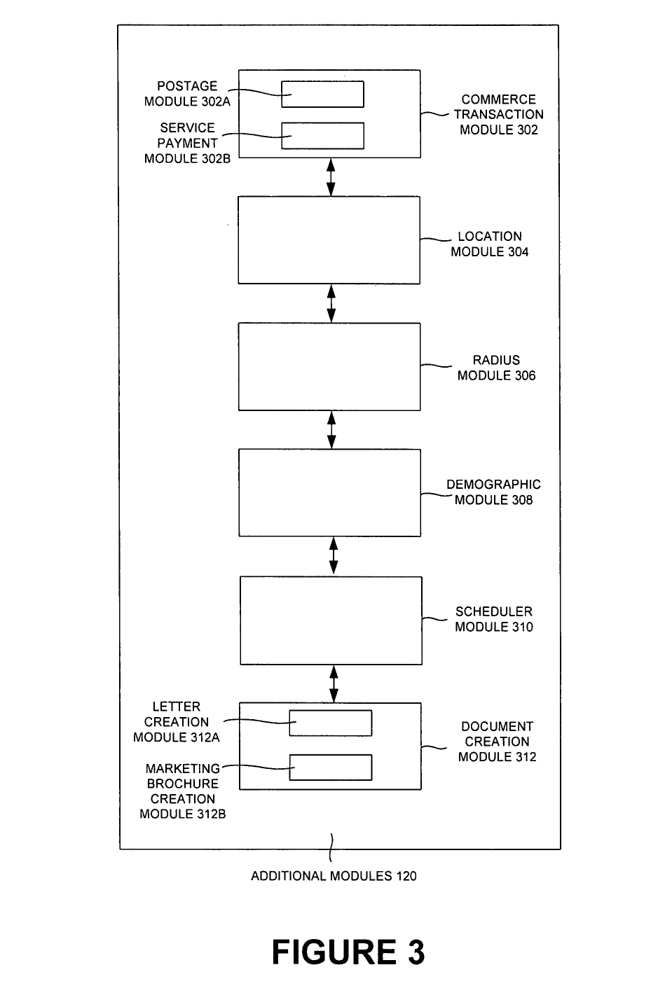

FIG. 3 is an exploded view of the additional modules 120 of FIG. 1, according to one embodiment. Particularly, FIG. 3 illustrates a commerce transaction module 302, a postage module 302A, a service payment module 302B, a location module 304, a radius module 306, a demographic module 308, a scheduler module 310, a document creation module 312, a letter creation module 312A and a marketing brochure creation module 312B, according to one embodiment.

The commerce transaction module 302 may generate a commerce transaction (e.g., the commerce transaction 408 of FIG. 4) associated with elements related to mailing of the communication 404. The postage module 302A may generate the online transaction associated with payment of postages. The service payment module 302B may generate the online transaction associated with payment of services related to the mailing of the communication 404. The location module 304 may represent a location (e.g., a street address, a city, a county, a state, a country, etc.) associated with the user profile 204 in the geo-spatial environment (e.g., the geo-spatial environment 100 of FIG. 1).

The radius module 306 may determine a radius based on the location and/or display a portion the user profiles 204 having specific geographic locations 206 within a threshold radius. The demographic module 308 may provide demographics (e.g., an age, an age range, a gender, an occupation, an ethnicity, a location of a residence, a location of a business, a martial status, an ownership status, a language, mobility, income, a life cycle, a socioeconomic status, a lifestyle, etc.) associated with the user profiles 204, select a demographic (e.g., the demographic may be associated with each user profile 204 of the group of user profiles 204), and/or determine a group of user profiles 204 of the portion of the user profiles 204. The scheduler module 310 may schedule the mailing of the communication 404 between the first user profile 204 and the contact address 210 associated with the second user profile 204A.

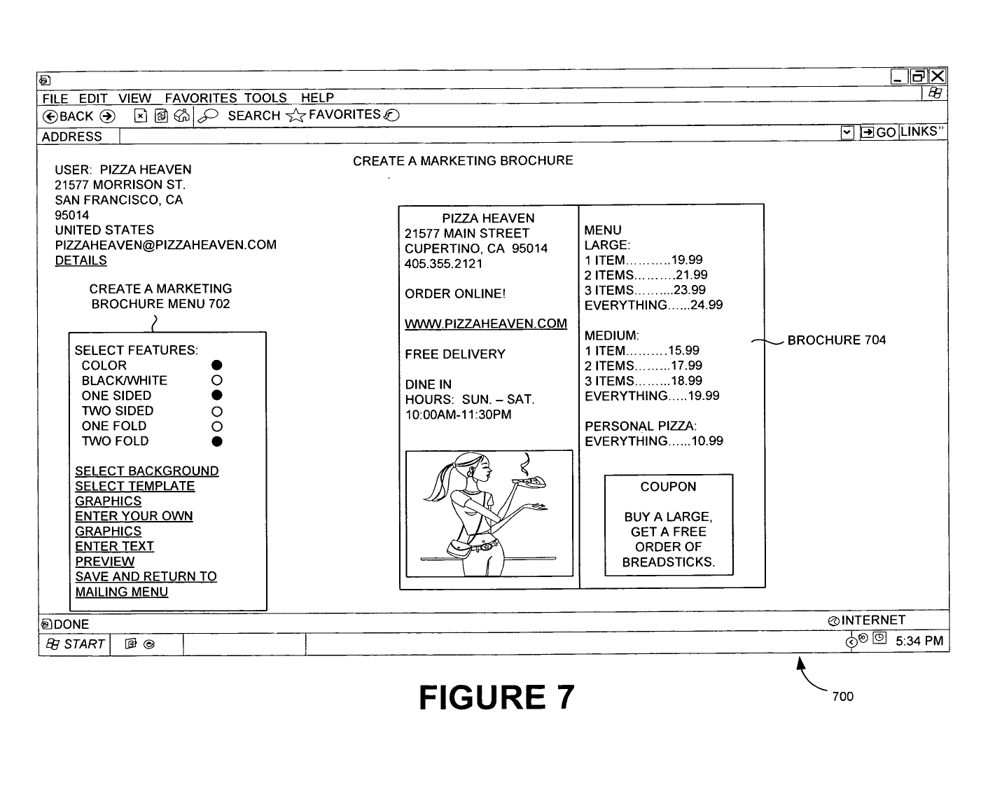

The document creation module 312 may generate the document associated with the communication 404 between the first user profile 204 and contact address 210 of the second user profile 204A. The letter creation module 312A may enable the users 102 to create letters for communication 404 between the first user profile 204 and the contact address 210 associated with the second user profile 204A. The marketing brochure creation module 312B may enable creation of marketing brochures (e.g., the brochures 704 of FIG. 7) in the geo-spatial environment (e.g., the geo-spatial environment 100 of FIG. 1).

In the example embodiment illustrated in FIG. 3, the additional modules 120 include the commerce transaction module 302, the location module 304, the radius module 306, the demographic module 308, the scheduler module 310 and the document creation module 312 communicating with each other. In addition, the commerce transaction module 302 includes the postage module 302A and the service payment module 302B. The document creation module 312 includes the letter creation module 312A and the marketing brochure creation module 312B, according to the example embodiment illustrated in FIG. 3.

The commerce transaction module 302 of the geo-spatial environment 100 may generate the commerce transaction 408 associated with the elements. The postage module 302A of the geo-spatial environment 100 may generate an online transaction associated with payment of postage. The service payment module 302B of the geo-spatial environment 100 may generate an online transaction associated with payment of services related to mailing the communication 404. The location module 304 may select the location (e.g., a street address, a city, a county, a state and/or a country, etc.) associated with the user profile 204.

The radius module 306 may determine a radius based on the location and/or display a portion of the user profiles 204 having specific geographic locations 206 of FIG. 2) included in the radius. The demographic module 308 may provide demographics (e.g., age, age range, gender, occupation, ethnicity, location of a residence, location of a business, marital status, ownership status, language, mobility, income, life cycle, socioeconomic status, and/or lifestyle, etc.) associated with the user profiles 204, to select demographic (e.g., may be associated with each user profile 204), and/or determine a group of user profiles 204. The scheduler module 310 may schedule (e.g., based on a selected number of mailings per a predetermined time period) the mailing. The document creation module 312 may enable creation of a document. The letter creation module 312A may enable creation of letters. The marketing brochure creation module 312B may enable creation of marketing brochures (e.g., the brochures 704 of FIG. 7).

FIG. 4 is a schematic representation of data communication between the first user 102 and the contact address 210 associated with the second user profile 204A, according to one embodiment. Particularly, FIG. 4 illustrates the network 104, the map data 122, the community network 200, the user database 202, the user profiles 204, the second user profile 204A, the contact address 210, a mail mode 402, a communication 404, a three-dimensional map view 406 and a commerce transaction 408, according to one embodiment.

The mail mode 402 may enable mailing of the communication 404 between the first user 102 associated with the first user profile 204 and the contact address 210 of the second user 102 associated with the second user profile 204A of the user profiles 204 through the mail mode 402 (e.g., a physical mode, a facsimile mode, an email mode, and/or an instant message mode, etc.). The communication 404 may be in the form of an online document, a text, a note, a memo, a pamphlet and/or a letter, etc. The three-dimensional map view 406 may enable the users 102 to view neighbor's profiles and their contact addresses (e.g., the contact address 210 of FIG. 2). The commerce transaction 408 may enable the users 102 to perform online transactions associated with payment of postages and/or payment of services related to mailing of the communication 404.

In the example embodiment illustrated in FIG. 4, the three-dimensional map view 406 may enable the users 102 to view their neighborhood profiles (e.g., the user profiles 204 of FIG. 2) and/or mail of the communication 404 through the mail mode 402. For example, a first user 102 associated with the first user profile 204 may communicate with the contact address 210 (e.g., 23232 Kettle Dr., Troy, Mich. 48084) of the second user profile 204A (e.g., Jane Doe's profile) through a physical mail mode by an online document through the network 104. In addition, the user 102 may make online transactions associated with payment of postages and services related to the mailing of the communication 404 through the commerce transaction option 408.

The mail mode 402 may be selected by the mail mode module 112 and/or the communication 404 may be selected by the communication module 110. A first display view may be generated (e.g., using the display module 114 of FIG. 1) to include the three-dimensional map view 406 embodied by the community network 200, a portion of the user profiles 204 represented at a location in the three-dimensional map view 406 associated with the specific geographic location 206 of the first user profile 204 of the user profiles 204. A second user profile 204A may be selected from the portion of the user profiles 204 and the mailing of the communication 404 may be generated, in a format associated with the mail mode 402, between the first user profile 204 and the contact address 210 associated with the second user profile 204A, in which the contact address 210 is based on the mail mode 402 (e.g., a physical mail mode, a facsimile mode, a email mode, and/or an instant message mode, etc.).

The physical mail mode (e.g., the mail mode 402 of FIG. 4) may be selected and the mailing of the communication 404 may be generated, in a physical format associated with the physical mail mode, between the first user profile 204 and the contact address 210 (e.g., the contact address 210 may be based on a physical address) associated with the second user profile 204A. The facsimile mode may be selected and the mailing of the communication 404 may be generated, in a facsimile format associated with the facsimile mode, between the first user profile 204 and the contact address 210 (e.g., the contact address 210 may be based on a facsimile number) associated with the second user profile 204A.

The email mode may be selected and the mailing of the communication 404 may be generated, in an email format associated with the email mode, between the first user profile 204 and the contact address 210 (e.g., the contact address 210 may be based on an email address) associated with the second user profile 204A. The instant message mode may be selected (e.g., using the mail mode module 112 of FIG. 1). A mailing of the communication 404 may be generated, in an instant message format associated with the instant message mode, between the first user profile 204 and the contact address 210 (e.g., the contact address 210 may be based on an instant message user identifier) associated with the second user profile 204A.

The location in the three-dimensional map view 406 may be selected from a group including a street address, a city, a county, a state, and/or a country, etc. The online commerce transaction 408 (e.g., payment of postage, payment of services, etc.) associated with the mailing of the communication 404 may be generated. The geo-spatial environment (e.g., the geo-spatial environment 100 of FIG. 1) may include a third instruction set integrated with the first instruction set and the second instruction set to determine a second user profile 204A of the portion of the user profiles 204, a communication (e.g., the communication 404 of FIG. 4), and/or a mail mode (e.g., the mail mode 402 of FIG. 4).

The geo-spatial environment (e.g., the geo-spatial environment 100 of FIG. 1) may include a fourth instruction set integrated with the first instruction set, the second instruction set and the third instruction set to generate a mailing of the communication 404, in a format associated with the mail mode 402, to the contact address 210 associated with the second user profile 204A, in which the contact address 210 is based on the mail mode 402. A fifth instruction set may generate a commerce transaction 408 associated with the mailing of the communication 404. A seventh instruction set may enable creation of the communication 404.

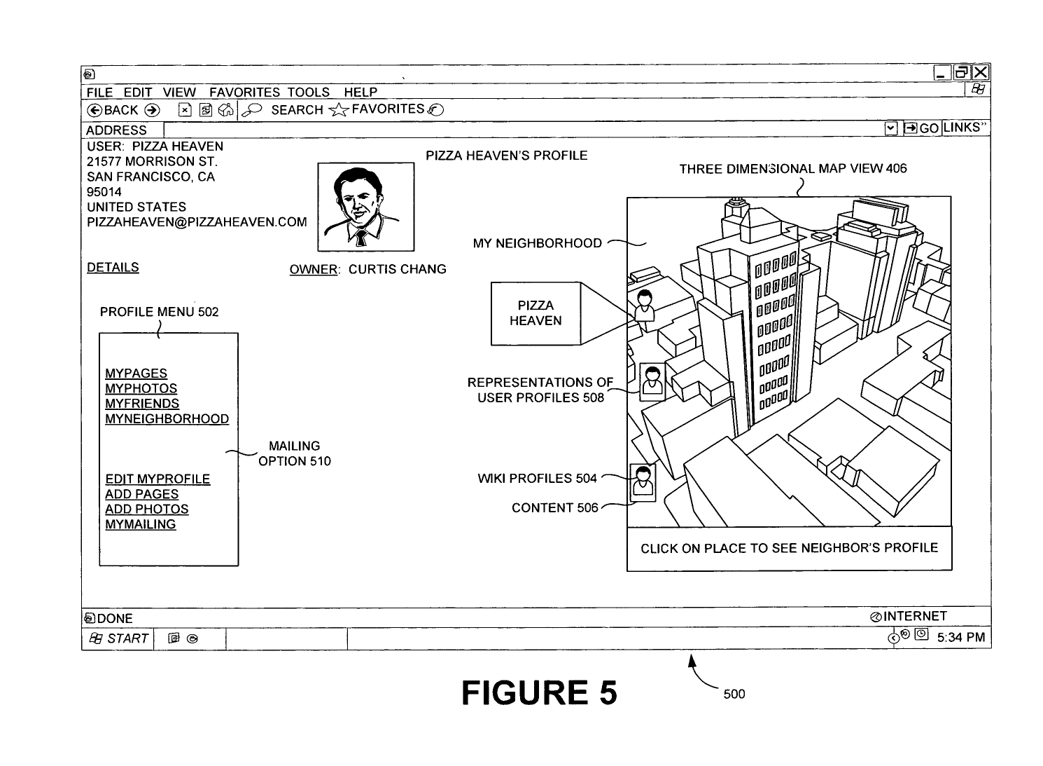

FIG. 5 is a user interface view 500 of Pizza Heaven's profile, according to one embodiment. Particularly, FIG. 5 illustrates a profile menu option 502, wiki profiles 504, content 506, representations of user profiles 508 and a mailing option 510, according to one embodiment.

The profile menu option 502 may enable a user (e.g., the users 102 of FIG. 1) to view his/her pages, photos, friends and/or neighborhood. The wiki profiles 504 may display profile information of the users 102 associated with a particular group in the three-dimensional map view 406. The content option 506 may provide information of the users 102 associated with the wiki profile 504 in his/her neighborhood. The representations of user profiles 508 may display profiles associated with the users 102 on the three-dimensional map view 406. The mailing option 510 may enable the users 102 to generate the mailing of the communication 404 through different mail modes (e.g., the mail mode 402 of FIG. 4).

In the example embodiment illustrated in FIG. 5, the user interface view 500 displays wiki profiles 504, the specific geographic location 206 associated with the user profile 204 involved in communication 404 and the representation of other profiles 204 in the three-dimensional map view 406. The user interface view 500 may enable the user 102 (e.g., Pizza Heaven) to view and/or edit content 506 in the profile 204, pages, photos, etc. using profile menu option 502.

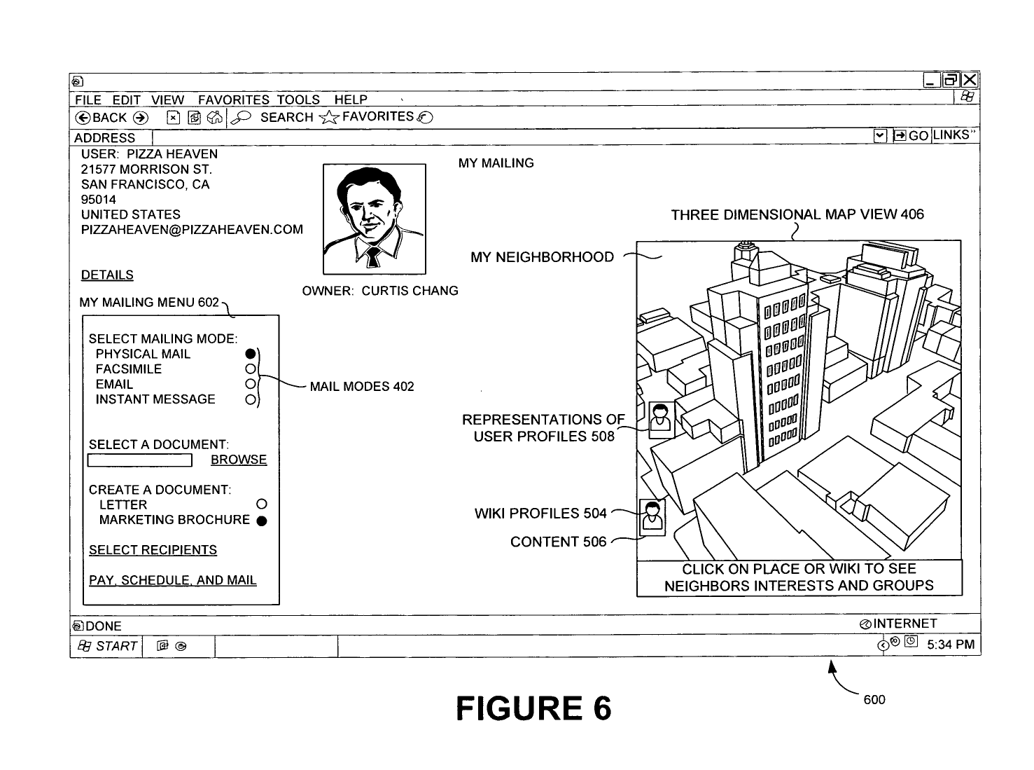

FIG. 6 is a user interface view 600 of a my mailing option 602, according to one embodiment. Particularly, FIG. 6 illustrates the mail modes 402, the three-dimensional map view 406, the wiki profiles 504, the content 506, the representations of user profiles 508 and a my mailing menu option 602, according to one embodiment. The my mailing menu option 602 may enable the users 102 to send/receive mails by selecting mail modes 402 (e.g., a physical mail mode, a facsimile mode, an email mode, an instant message, etc.). The my mailing menu option 602 may enable the users 102 to create documents, letters and/or marketing brochures (e.g., the brochures 704 of FIG. 7) associated with mailing of the communication 404 through mail modes (e.g., the mail mode 402 of FIG. 4).

In the example embodiment illustrated in FIG. 6, the user interface view 600 may enable the user 102 (e.g., Pizza Heaven) to send/receive mails through the selected mail modes 402. In addition, the user 102 may create a document (e.g., letter, marketing brochure, etc.), pay for postages, make payment of services related to the mailing of the communication 404 and/or schedule a mail to be sent to the recipients through a pay, schedule and mail link. The user interface view 600 may also enable the users 102 to select the desired recipients involved in the mailing of the communication 404 through a select recipient link of the my mailing menu option 602. In addition, the user interface view 600 displays the three-dimensional map view 406 which represents the wiki profiles 504 and/or the representations of user profiles 508.

FIG. 7 is a user interface view 700 of the marketing brochure creation module 312B of FIG. 3, according to one embodiment. Particularly, FIG. 7 illustrates a create a marketing brochure menu option 702 and a brochure 704, according to one embodiment. The create a marketing brochure menu option 702 may enable the users 102 to create a brochure 704 by selecting features (e.g., color, black/white, one sided, two sided, one fold and/or two fold). The brochure 704 may displays a preview of the marketing brochure created by the users 102 using the create a marketing brochure menu option 702

In the example embodiment illustrated in FIG. 7, the user interface view 700 displays selected options for a color, one sided, and two fold marketing brochure created by the user 102 (e.g., Pizza Heaven) using the create a marketing brochure menu option 702. The user interface view 700 may enable the users 102 to select background and/or template graphics through a select background link and/or a select template graphics link of the create a marketing brochure menu option 702. In addition, the user interface view 700 may provide a preview link to view the preview of the brochure 704 created by Pizza Heaven. A save and return to mailing menu link of the create a marketing brochure menu option 702 may enable the user 102 to save the created brochure 704 and return to the my mailing page. Additionally, an enter your own graphics link and an enter text link displayed in the create a marketing brochure menu option 702 may enable the users 102 to insert the graphics, and/or the text.

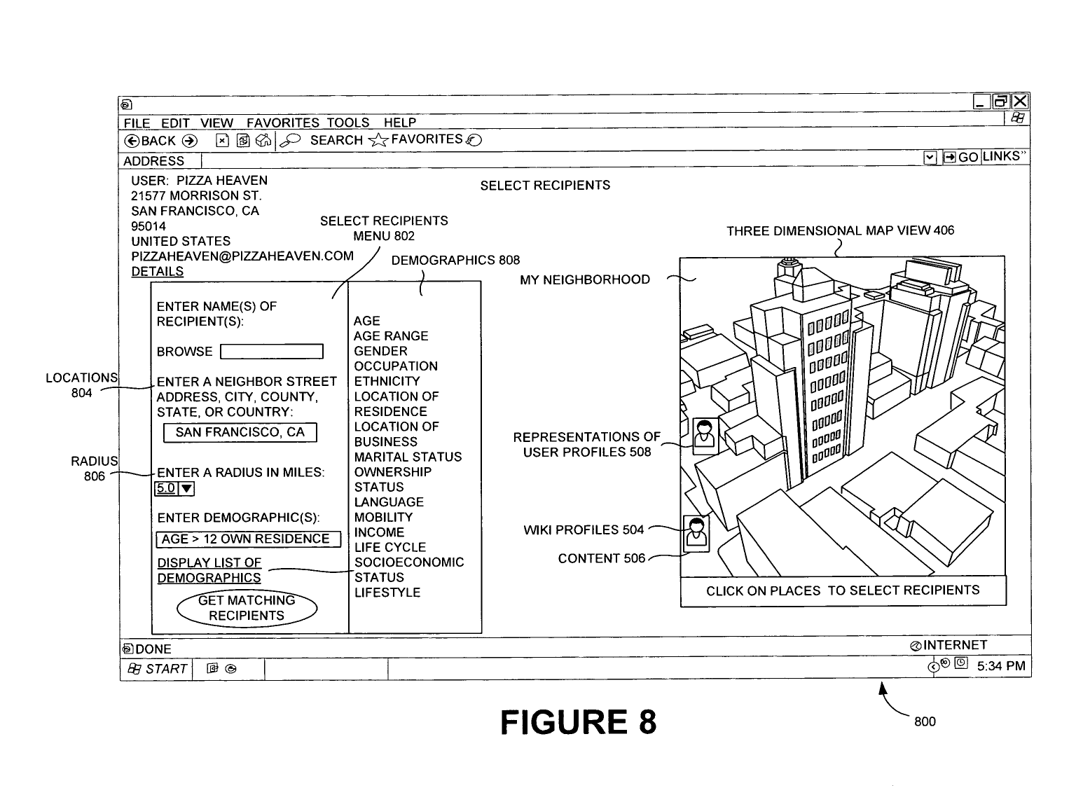

FIG. 8 is a user interface view 800 of the recipient module 116 of FIG. 1, according to one embodiment. Particularly, FIG. 8 illustrates the three-dimensional map view 406, the wiki profiles 504, the content 506, the representations of user profiles 508, a select recipients menu option 802, a location field 804, a radius field 806 and demographics option 808, according to one embodiment.

The select recipients menu option 802 may enable the users 102 to communicate by selecting recipients having specific geographic locations 206 within a radius. The location field 804 may enable the users 102 to select the locations associated with the recipient(s) from a group including a street address, a city, a county, a state and a country. The radius field 806 may enable the users 102 to select the recipients located a threshold radius away from the user 102. The demographics option 808 may enable the users 102 to determine a group of user profiles 204 based on age, age range, gender, occupation, ethnicity, location of a residence, location of a business, martial status, ownership status, language, mobility, income, life cycle, socioeconomic status, and/or lifestyle, etc. associated with the recipient(s).

In the example embodiment illustrated in FIG. 8, the user interface view 800 may enable the user 102 (e.g., Pizza Heaven) to select recipients from the select recipients menu option 802 based on a name, a location (e.g., San Francisco), a radius (e.g., 5 miles) and/or demographics (e.g., age, residence). In addition, the user interface view 800 may enable the users 102 to view various demographics using a display list of demographics link of the select recipients menu option 802.

A get menu link displayed in the select recipients menu option 802 facilitates the users 102 to find matching recipients by selecting the demographics (e.g., age >12, own residence) from the demographics option 808. The user interface view 800 may enable the users 102 to select the desired recipients involved in the mailing of the communication 404 through selecting the locations of the recipients displayed in the three-dimensional map view 406. In addition, the user interface view 800 also displays in the three-dimensional map view 406, the wiki profiles 504 and/or the representations of user profiles 508.

The radius 806 associated with a location in the three-dimensional map view 406 may be selected (e.g., using the radius module 306 of FIG. 3), the user profiles 204 of the portion of the user profiles 204 having specific geographic locations 206 included in the radius 806 may be selected (e.g., using the location module 304 of FIG. 3), and/or the demographics 808 associated with the community network 200 may be provided (e.g., through the demographic module 308 of FIG. 3). The demographics 808 may be associated with each user profile 204. A demographic 808 may be selected, and/or the user profiles 204 having specific geographic locations 206 included in the radius 806 and having the demographic (e.g., age, age range, gender, occupation, ethnicity, location of a residence, location of a business, marital status, ownership status, language, mobility, income, life cycle, socioeconomic status, and/or lifestyle, etc.) may be selected.

The geo-spatial environment (e.g., the geo-spatial environment 100 of FIG. 1) may include a second instruction set integrated with the first instruction set to display a three-dimensional map view 406, embodied by the community network 200, to include representations of a portion of the user profiles 204, in which each representation of a user profile 204 is displayed at a location in the three-dimensional map view 406 corresponding to the specific geographic location 206 associated with the user profile 204.

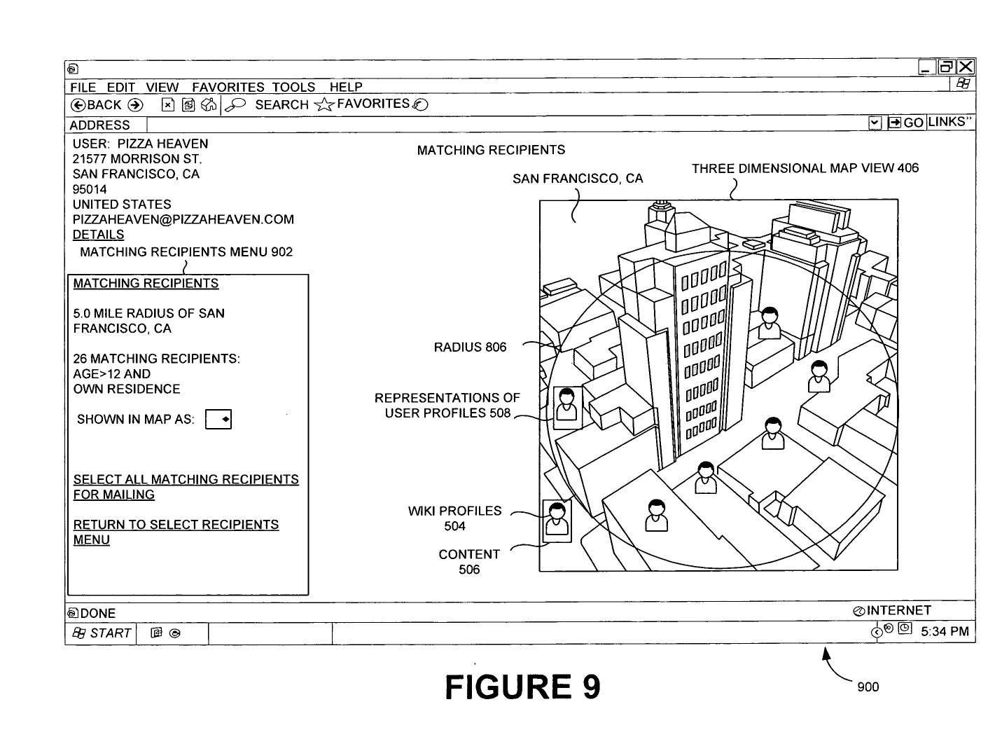

FIG. 9 is a user interface view 900 of selecting the matching recipients for mailing of the communication 404, according to one embodiment. Particularly, FIG. 9 illustrates the three-dimensional map view 406, the wiki profiles 504, the content 506, the representations of user profiles 508, the radius 806 and a matching recipients menu option 902, according to one embodiment. The matching recipients menu option 902 may enable the users 102 to select the recipient(s) having matching demographic(s) (e.g., an age, a residence, and/or an age range, etc.) and located within the radius 806 associated with the geographic location specified by the users 102.

In the example embodiment illustrated in FIG. 9, the user interface view 900 displays in the three-dimensional map view 406, the matching recipients located within the radius 806 associated with the geographic location adjacent to the other user profiles 204. The matching recipients menu option 902 of user interface view 900 displays numbers of recipients having matching demographic(s) 808 (e.g., age >12 and own residence, etc.) and located within the radius 806 (e.g., 5 miles) associated with the location (e.g., San Francisco, Calif.).

In addition, the user interface view 900 may enable the user 102 (e.g., Pizza Heaven) to select all the matching recipients for mailing of the communication 404 using a select all matching recipients for mailing link of the matching recipients menu option 902. The user interface view 900 displays in the three-dimensional map view 406, the wiki profiles 504, the content 506 associated with the wiki profiles 504 and the representations of user profiles 508 adjacent to the profiles 204 associated with the matching recipients.

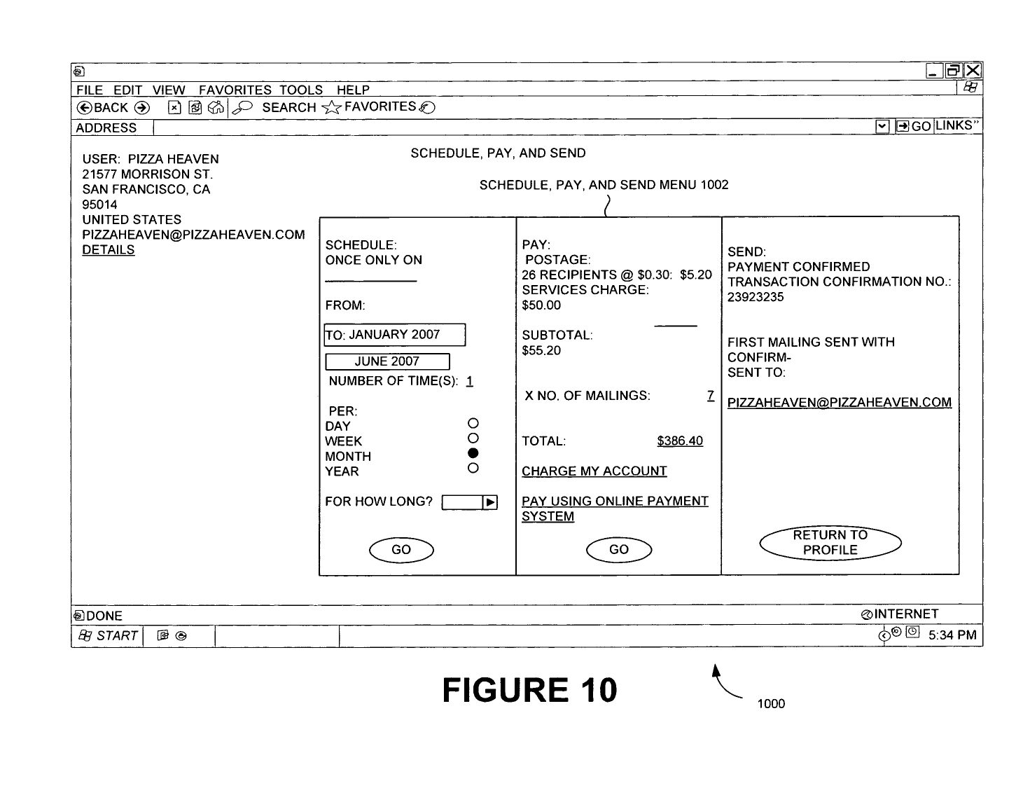

FIG. 10 is a user interface view 1000 of scheduling, sending mails and making transactions associated with payment of services related to mailing of the communication 404, according to one embodiment. Particularly, FIG. 10 illustrates a schedule, pay, and send menu option 1002, according to one embodiment. The schedule, pay, and send menu option 1002 may enable the user 102 to schedule a time period for mailing and making transactions associated with the payment of postages and/or the payment of services related to mailing of the communication 404.

In the example embodiment illustrated in FIG. 10, the user interface view 1000 displays the scheduled time period (e.g., per week, for a period of 6 months, etc.) for mailing of the communication 404 and transaction details associated with the payment of postage and/or services. The user interface view 1000 may enable the user 102 (e.g., Pizza Heaven) to schedule (e.g., from January 2007 to June 2007, weekly, monthly, daily, yearly, number of times, etc.) the mailing to the recipient(s).

In addition, a pay using online payment system link of the schedule, pay, and send menu option 1002 may enable the user 102 to make online transactions associated with the payment of postages and/or services. The users 102 may make online payment of postages (e.g., @ $0.30 per recipient for a total of 26 matching recipients) and/or payment of services (e.g., @ $50.00) related to the mailing of the communication 404 to the recipients. The users 102 may send any number of mailings per a predetermined time period (e.g., per day, week, month and/or year).

The user 102 (e.g., Pizza Heaven) may send mails to the recipients upon receiving a transaction confirmation number (e.g., 23923235) associated with confirmation of payment. The user interface view 1000 also displays delivery status of the mailings to the recipients in the schedule, pay, and send menu option 1002. A return to profile option may enable the users 102 to revisit the profile 204 associated with the user 102. The mailing of the communication 404 may be scheduled (e.g., by determining a number of mailings, a time period and/or generating the number of mailings within the time period). The geo-spatial environment (e.g., the geo-spatial environment 100 of FIG. 1) may include a sixth instruction set to schedule the mailing of the communication 404.

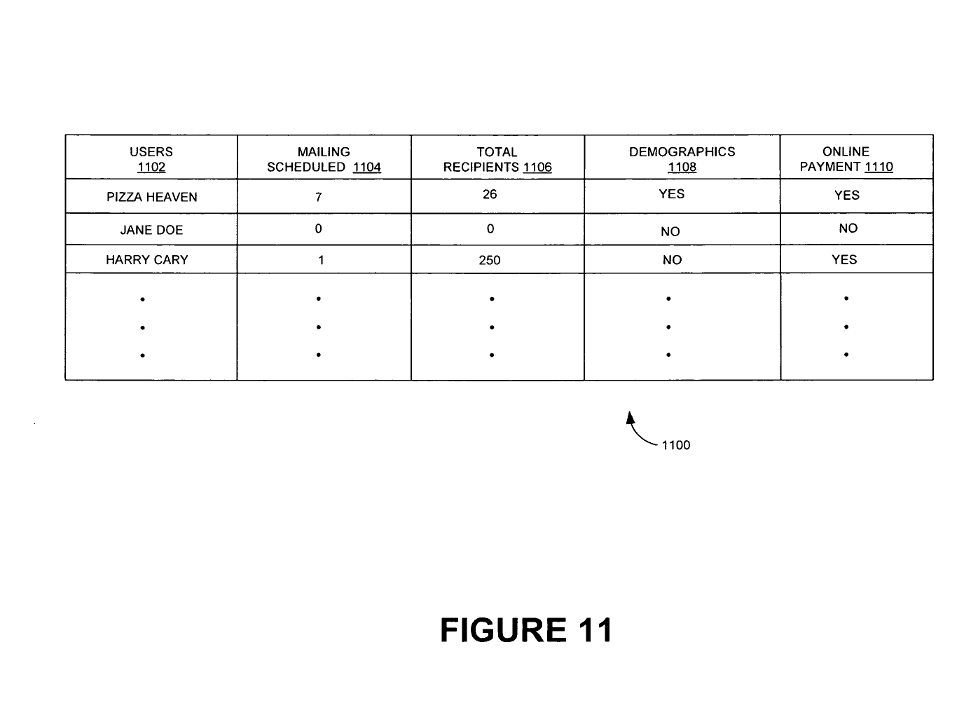

FIG. 11 is a table view 1100 showing details of mailing of the communication 404 associated with the users 102, according to one embodiment. Particularly, FIG. 11 illustrates a users field 1102, a mailing scheduled field 1104, a total recipients field 1106, a demographics field 1108 and an online payment field 1110, according to one embodiment.

The users field 1102 may display the names of users (e.g., the users 102 of FIG. 1) associated with the mailing of the communication 404 through the mail mode 402. The mailing scheduled field 1104 may display the number of mailings scheduled within a time period by a particular user 102. The total recipients field 1106 may display total number of recipients scheduled to be mailed by the users 102. The demographics field 1108 may display the status of the demographics (e.g., the demographics 808 of FIG. 8) associated with the user 102. The online payment field 1110 may display an online transaction status associated with the payment of postages and/or services related to mailing the communication 404.

In the example embodiment illustrated in FIG. 11, the users field 1102 displays “Pizza Heaven” in the first row, “Jane Doe” in the second row and “Harry Cary” in the third row of the users field 1102 column. The mailing scheduled field 1104 displays “7” in the first row, “0” in the second row, and “1” in the third row of the mailing scheduled field 1104 column (e.g., 7 mailings scheduled by Pizza Heaven, no mailings scheduled by Jane Doe and 1 mailing scheduled by Harry Cary). The total recipients field 1106 displays “26” recipients for Pizza Heaven in the first row, “0” recipients for Jane Doe in the second row and “250” recipients for Harry Cary in the third row of the total recipients field 1106 column. The demographics field 1108 displays “Yes” in the first row, “No” in the second row and “No” in the third row of the demographics field 1108 column (e.g., Pizza Heaven has demographics while Jane Doe and Harry Cary do not have demographics). The online payment field 1110 displays “Yes” in the first row, “No” in the second row and “Yes” in the third row of the online payment field 1110 column (e.g., Pizza Heaven and Harry Cary make online payments and Jane Doe does not make online payments).

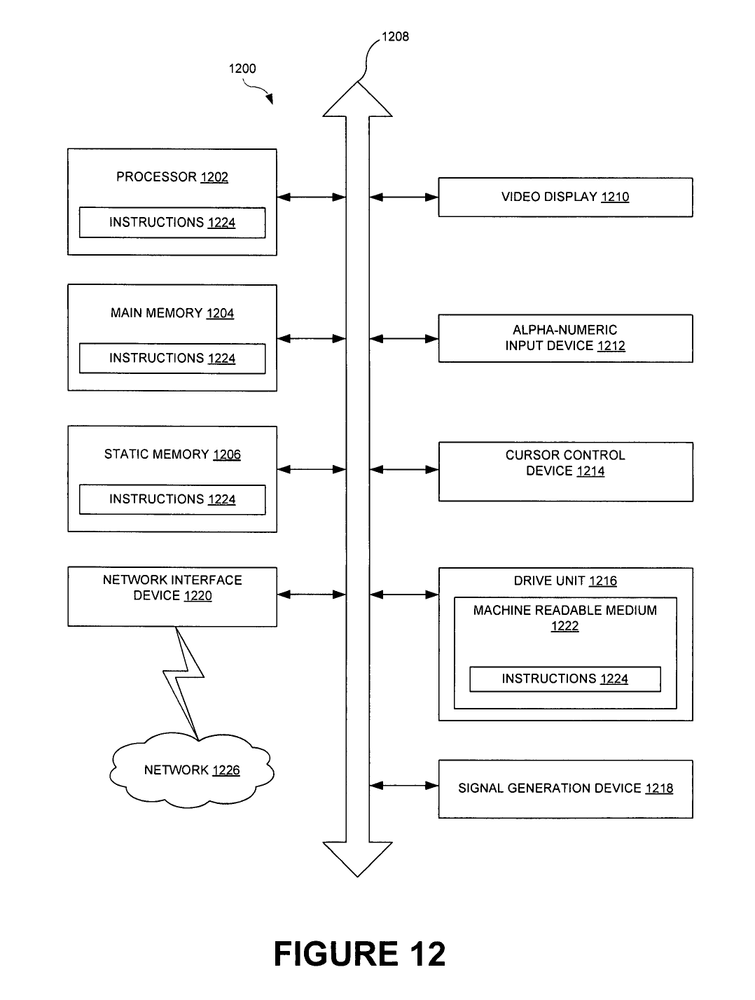

FIG. 12 is a diagrammatic system view 1200 of a data processing system in which any of the embodiments disclosed herein may be performed, according to one embodiment. Particularly, the system view 1200 of FIG. 12 illustrates a processor 1202, a main memory 1204, a static memory 1206, a bus 1208, a video display 1210, an alpha-numeric input device 1212, a cursor control device 1214, a drive unit 1216, a signal generation device 1218, a network interface device 1220, a machine readable medium 1222, instructions 1224 and a network 1226, according to one embodiment.

The diagrammatic system view 1200 may indicate a personal computer and/or a data processing system in which one or more operations disclosed herein may be performed. The processor 1202 may be a microprocessor, a state machine, an application-specific integrated circuit, a field programmable gate array, etc. (e.g., Intel® Pentium® processor). The main memory 1204 may be a dynamic random access memory and/or a primary memory of a computer system. The static memory 1206 may be a hard drive, a flash drive, and/or other memory information associated with the data processing system.

The bus 1208 may be an interconnection between various circuits and/or structures of the data processing system. The video display 1210 may provide graphical representation of information on the data processing system. The alpha-numeric input device 1212 may be a keypad, a keyboard and/or any other input device of text (e.g., a special device to aid the physically challenged). The cursor control device 1214 may be a pointing device such as a mouse.

The drive unit 1216 may be the hard drive, a storage system, and/or other longer term storage subsystem. The signal generation device 1218 may be a bios and/or a functional operating system of the data processing system. The network interface device 1220 may be a device that may perform interface functions such as code conversion, protocol conversion and/or buffering required for communication to and from the network 1226. The machine readable medium 1222 may provide instructions on which any of the methods disclosed herein may be performed. The instructions 1224 may provide source code and/or data code to the processor 1202 to enable any one/or more operations disclosed herein.

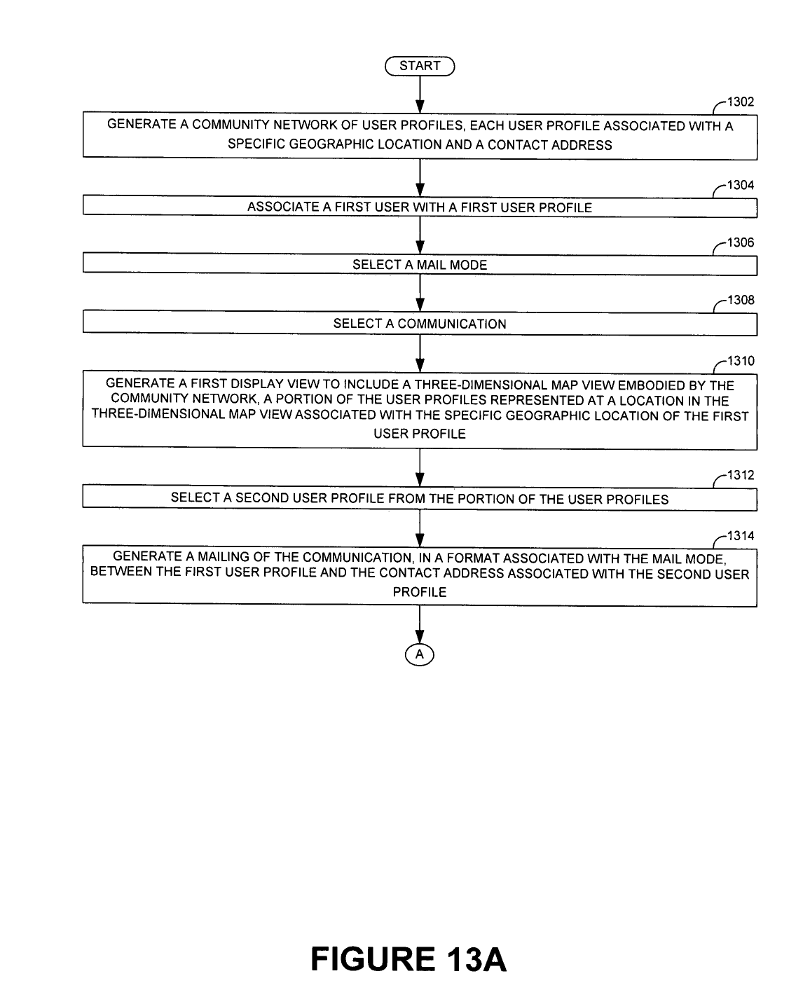

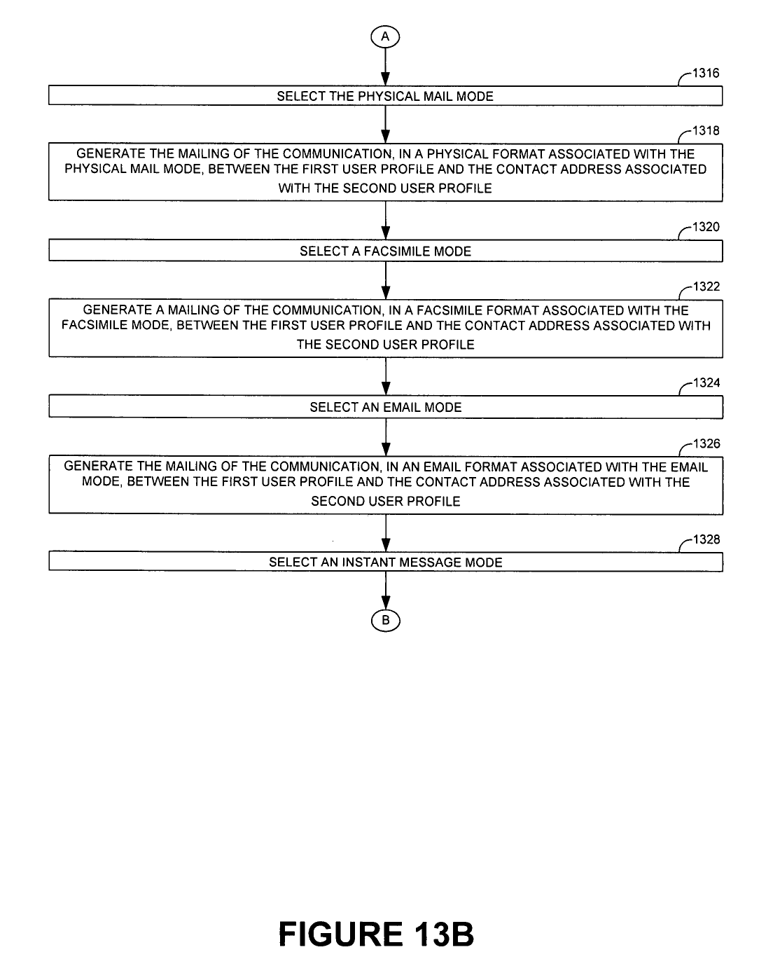

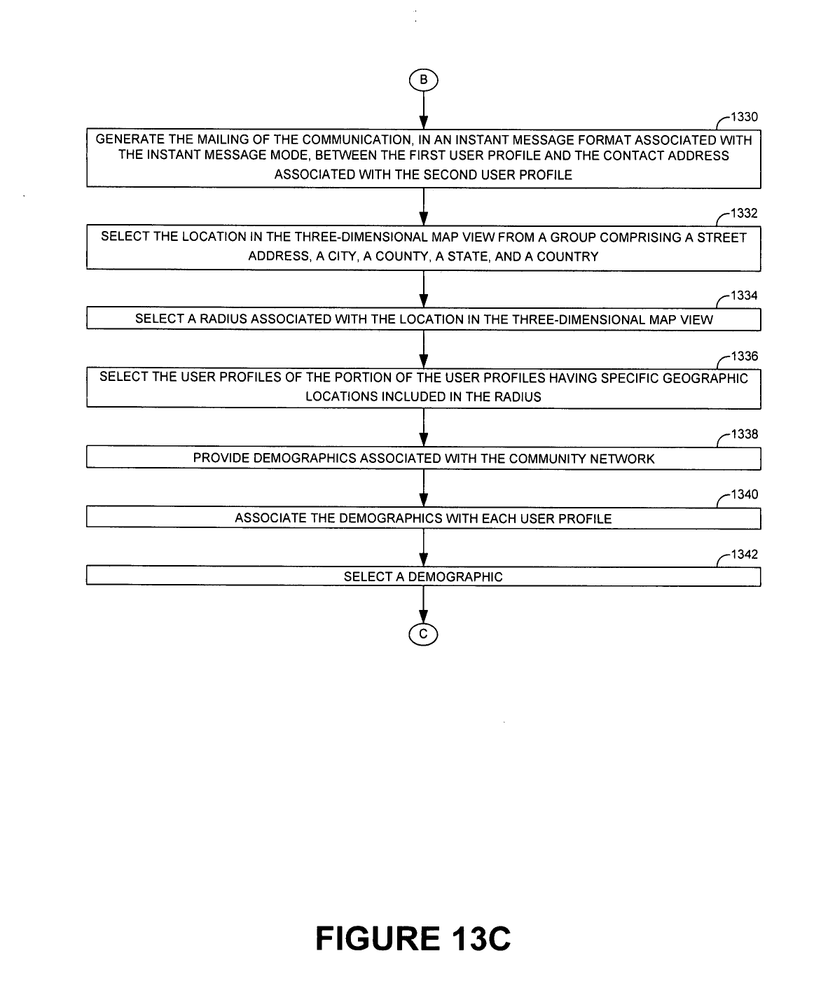

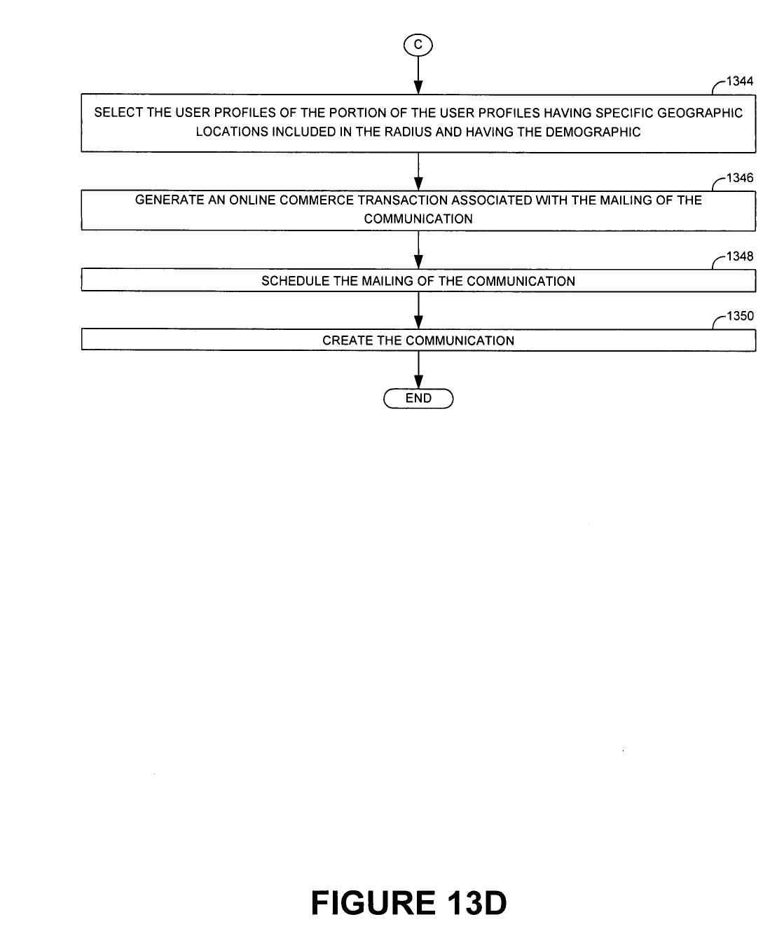

FIG. 13A is a process flow of direct mailing based on the selection of mailing modes, according to one embodiment. In operation 1302, a community network (e.g., the community network 200 of FIG. 2) of user profiles (e.g., the user profiles 204 of FIG. 2) may be generated (e.g., using the community network module 106 of FIG. 1), each user profile 204 associated with a specific geographic location (e.g., the specific geographic location 206 of FIG. 2) and/or a contact address (e.g., the contact address 210 of FIG. 2). In operation 1304, a first user 102 may be associated with a first user profile 204. In operation 1306, a mail mode 402 may be selected (e.g., using the mail mode module 112 of FIG. 1). In operation 1308, a communication (e.g., the communication 404 of FIG. 4) may be selected (e.g., through the communication module 110 of FIG. 1).

In operation 1310, a first display view may be generated (e.g., through the display module 114 of FIG. 1), to include a three-dimensional map view (e.g., the three-dimensional map view 406 of FIG. 4) embodied by the community network 200, a portion of the user profiles 204 represented at a location in the three-dimensional map view 406 associated with the specific geographic location 206 of the first user profile 204. In operation 1312, a second user profile 204A may be selected from the portion of the user profiles 204. In operation 1314, a mailing of the communication 404 may be generated (e.g., using the mail communication module 118 of FIG. 1), in a format associated with the mail mode 402, between the first user profile 204 and the contact address 210 associated with the second user profile 204A.

FIG. 13B is a continuation of the process flow of FIG. 13A illustrating additional processes, according to one embodiment. In operation 1316, the physical mail mode (e.g., the mail mode 402 of FIG. 4) may be selected (e.g., using the mail mode module 112 of FIG. 1). In operation 1318, the mailing of the communication 404 may be generated (e.g., using the mail communication module 118 of FIG. 1), in a physical format associated with the physical mail mode, between the first user profile 204 and the contact address 210 associated with the second user profile 204A.

In operation 1320, a facsimile mode may be selected (e.g., through the mail mode module 112 of FIG. 1). In operation 1322, a mailing of the communication 404 may be generated (e.g., using the mail communication module 118 of FIG. 1), in a facsimile format associated with the facsimile mode, between the first user profile 204 and the contact address 210 associated with the second user profile 204A. In operation 1324, an email mode may be selected (e.g., using the mail mode module 112 of FIG. 1). In operation 1326, the mailing of the communication may be generated (e.g., through the mail communication module 118 of FIG. 1), in an email format associated with the email mode, between the first user profile 204 and the contact address 210 associated with the second user profile 204A. In operation 1328, an instant message mode may be selected (e.g., through the mail mode module 112 of FIG. 1).

FIG. 13C is a continuation of the process flow of FIG. 13B illustrating additional processes, according to one embodiment. In operation 1330, the mailing of the communication (e.g., the communication 404 of FIG. 4) may be generated (e.g., using the mail communication module 118 of FIG. 1), in an instant message format associated with the instant message mode, between the first user profile 204 and the contact address 210 associated with the second user profile 204A. In operation 1332, the location in the three-dimensional map view 406 may be selected (e.g., using the location module 304 of FIG. 3) from a group including a street address, a city, a county, a state, and/or a country, etc.

In operation 1334, a radius (e.g., the radius 806 of FIG. 8) associated with the location in the three-dimensional map view 406 may be selected (e.g., using the radius module 306 of FIG. 3). In operation 1336, the user profiles 204 having specific geographic locations 206 included in the radius 806 may be selected (e.g., using the recipient module 116 of FIG. 1). In operation 1338, demographics associated with the community network 200 may be provided (e.g., through the demographic module 308 of FIG. 3). In operation 1340, the demographics 808 may be associated with each user profile 204. In operation 1342, a demographic 808 may be selected (e.g., using the demographic module 308 of FIG. 3).

FIG. 13D is a continuation of the process flow of FIG. 13C, illustrating additional processes, according to one embodiment. In operation 1344, the user profiles 204 having the specific geographic locations 206 included in the radius 806 and having the demographic 808 may be selected (e.g., using the recipient module 116 of FIG. 1). In operation 1346, an online commerce transaction (e.g., the commerce transaction 408 of FIG. 4) associated with the mailing of the communication (e.g., the communication 404 of FIG. 4) may be generated (e.g., through commerce transaction module 302 of FIG. 2). In operation 1348, the mailing of the communication 404 may be scheduled (e.g., using the scheduler module 310 of FIG. 3). In operation 1350, the communication 404 may be created (e.g., using document creation module 312 of FIG. 3).

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the community network module 106, the map module 108, the communication module 110, the mail mode module 112, the display module 114, the recipient module 116, the mail communication module 118, the additional modules 120, the commerce transaction module 302, the postage module 302A, the service payment module 302B, the location module 304, the radius module 306, the demographic module 308, the scheduler module 310, the document creation module 312, the letter creation module 312A, the marketing brochure creation module 312B, and other modules of FIGS. 1-13 may be enabled using a community network circuit, a map circuit, a communication circuit, a mail mode circuit, a display circuit, a recipient circuit, a mail communication circuit, additional circuits, a commerce transaction circuit, a postage circuit, a service payment circuit, a location circuit, a radius circuit, a demographic circuit, a scheduler circuit, a document creation circuit, a letter creation circuit, a marketing brochure creation circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method, comprising:
generating a community network of user profiles, each user profile of the user profiles associated with a specific geographic location and at least one contact address;
associating a first user with a first user profile of the user profiles;
selecting a mail mode;
selecting a communication;
generating a first display view to include a three-dimensional map view embodied by the community network, at least a portion of the user profiles represented at a location in the three-dimensional map view associated with the specific geographic location of the first user profile of the user profiles;
selecting a second user profile from the at least a portion of the user profiles; and
generating a mailing of the communication, in a format associated with the mail mode, between the first user profile of the user profiles and the contact address associated with the second user profile of the user profiles, wherein the contact address is based on the mail mode.

2. The method of claim 1, wherein the selecting the mail mode comprises:
selecting at least one of a physical mail mode, a facsimile mode, an email mode, and an instant message mode.

3. The method of claim 1, wherein the contact address is selected from a group comprising: a physical mailing address associated with the specific geographic location of the user profile, a facsimile number, an email address, and an instant message user identifier.

4. The method of claim 3, further comprising:
selecting a physical mail mode; and
generating the mailing of the communication, in a physical format associated with the physical mail mode, between the first user profile of the user profiles and the contact address associated with the second user profile of the user profiles, wherein the contact address is based on a physical address associated with the second user profile of the user profiles.

5. The method of claim 3, further comprising:
selecting a facsimile mode; and
generating the mailing of the communication, in a facsimile format associated with the facsimile mode, between the first user profile of the user profiles and the contact address associated with the second user profile of the user profiles, wherein the contact address is based on the facsimile number associated with the second user profile of the user profiles.

6. The method of claim 3, further comprising:
selecting an email mode; and
generating the mailing of the communication, in an email format associated with the email mode, between the first user profile of the user profiles and the contact address associated with the second user profile of the user profiles, wherein the contact address is based on the email address associated with the second user profile of the user profiles.

7. The method of claim 3, further comprising:
selecting an instant message mode; and
generating the mailing of the communication, in an instant message format associated with the instant message mode, between the first user profile of the user profiles and the contact address associated with the second user profile of the user profiles, wherein the contact address is based on the instant message user identifier associated with the second user profile of the user profiles.

8. The method of claim 1, further comprising:
selecting the location in the three-dimensional map view from a group comprising: a street address, a city, a county, a state, and a country.

9. The method of claim 8, further comprising:
selecting a radius associated with the location in the three-dimensional map view; and
selecting the user profiles of the at least a portion of the user profiles having specific geographic locations included in the radius.

10. The method of claim 9, further comprising:
providing demographics associated with the community network;
associating at least one of the demographics with each user profile of the user profiles;
selecting at least one demographic of the demographics; and
selecting the user profiles of the at least a portion of the user profiles having specific geographic locations included in the radius and having the at least one demographic of the demographics.

11. The method of claim 10, wherein the demographics include an age, an age range, a gender, an occupation, an ethnicity, a location of a residence, a location of a business, a marital status, an ownership status, a language, mobility, income, a life cycle, a socioeconomic status, and a lifestyle.

12. The method of claim 1, further comprising:
generating an online commerce transaction associated with the mailing of the communication.

13. The method of claim 12, wherein the generating the online commerce transaction comprises at least one of:
generating an online transaction associated with payment of postage; and
generating an online transaction associated with payment of services related to the mailing of the communication.

14. The method of claim 1, further comprising:
scheduling the mailing of the communication.

15. The method of claim 14, wherein the scheduling the mailing of the communication comprises:
determining a number of mailings;
determining a time period; and
generating the number of mailings within the time period.

16. The method of claim 1, further comprising:
creating the communication.

17. The method of claim 1 in a form of a machine-readable medium embodying a set of instructions that, when executed by a machine, causes the machine to perform the method of claim 1.

18. A system, comprising:
a geo-spatial environment;
a community network module of the geo-spatial environment, to include user profiles, each user profile of the user profiles to include a specific geographic location and a contact address;
a map module of the geo-spatial environment to include map data which serves as a basis to render a three-dimensional map view in the geo-spatial environment which identifies at least some residences, businesses, and civic structures having specific geographic locations;
a mail mode module of the geo-spatial environment to determine a mail mode;
a communication module of the geo-spatial environment to select a communication;
a display module of the geo-spatial environment to generate a first display view to include a three-dimensional map view embodied by a community network, at least a portion of the user profiles represented at locations in the three-dimensional map view associated with the specific geographic locations of the at least a portion of the user profiles;
a recipient module of the geo-spatial environment to select a user profile from the at least a portion of the user profiles; and
a mail communication module of the geo-spatial environment to generate a mailing of the communication, in a format associated with the mail mode, to a contact address associated with the user profile of the user profiles.

19. The system of claim 18, further comprising:
a commerce transaction module of the geo-spatial environment to generate a commerce transaction associated with the elements.

20. The system of claim 19, further comprising:
a postage module of the geo-spatial environment to generate an online transaction associated with payment of postage; and
a service payment module of the geo-spatial environment to generate an online transaction associated with payment of services related to mailing the communication.

21. The system of claim 18, further comprising:
a location module to select the location, wherein the location is selected from a group comprising: a street address, a city, a county, a state, and a country.

22. The system of claim 18, further comprising:
a radius module to determine a radius based on the location and to display the at least a portion of the user profiles having specific geographic locations included in the radius.

23. The system of claim 18, further comprising:
a demographic module to provide demographics associated with the user profiles;
to select at least one demographic of the demographics, and to determine a group of user profiles of the at least a portion of the user profiles, wherein the at least one demographics is associated with each user profiles of the group of user profiles.

24. The system of claim 23, wherein the demographic is selected from a group comprising an age, an age range, a gender, an occupation, an ethnicity, a location of a residence, a location of a business, a marital status, an ownership status, a language, mobility, income, a life cycle, a socioeconomic status, and a lifestyle.

25. The system of claim 18, further comprising:
a scheduler module to schedule the mailing.

26. The system of claim 25, wherein the schedule is based on a selected number of mailings per a predetermined time period.

27. The system of claim 18, further comprising:
a document creation module to enable creation of a document.

28. The system of claim 27, further comprising:
a letter creation module to enable creation of letters; and
a marketing brochure creation module to enable creation of marketing brochures.

29. The system of claim 18, wherein the mail mode is selected from a group comprising a physical mail mode, a facsimile mode, an email mode, and an instant message mode.

30. The system of claim 18, wherein the contact address is selected from a group comprising a physical mailing address associated with the specific geographic location of the user profile, a facsimile number, an email address, and an instant message user identifier.

31. A geo-spatial environment, comprising:
a first instruction set to enable a community network, to include a map database associated with map data and a user database associated with user profiles, each user profile of the user profiles associated with a specific geographic location identifiable in the map data and a contact address;
a second instruction set integrated with the first instruction set to display a three-dimensional map view, embodied by the community network, to include representations of at least a portion of the user profiles, wherein each representation of a user profile of the at least a portion of the user profiles is displayed at a location in the three-dimensional map view corresponding to the specific geographic location associated with the user profile;
a third instruction set integrated with the first instruction set and the second instruction set to determine a second user profile of the at least a portion of the user profiles, a communication, and a mail mode; and
a fourth instruction set integrated with the first instruction set and the second instruction set and the third instruction set to generate a mailing of the communication, in a format associated with the mail mode, to the contact address associated with the second user profile of the user profiles, wherein the contact address is based on the mail mode.

32. The geo-spatial environment of claim 31, further comprising:
a fifth instruction set to generate a commerce transaction associated with the mailing of the communication.

33. The geo-spatial environment of claim 31, further comprising:
a sixth instruction set to schedule the mailing of the communication.

34. The geo-spatial environment of claim 21, further comprising:
a seventh instruction set to enable creation of the communication.
